(19) United States
(12) Patent Application Publication
(10) Pub. No.: US 2017/0251089 A1
(43) Pub. Date: Aug. 31, 2017

(54) ANTIMICROBIAL MOBILE COMMUNICATIONS DEVICE

(71) Applicant: Steven Powell, River Forest, IL (US)

(72) Inventor: Steven Powell, River Forest, IL (US)

(21) Appl. No.: 15/442,836

(22) Filed: Feb. 27, 2017

Related U.S. Application Data
(60) Provisional application No. 62/300,304, filed on Feb. 26, 2016.

(51) Int. Cl. H04M 1/17; A01N 59/16; H04M 1/02; A01N 25/08

(52) U.S. Cl. CPC H04M 1/17; A01N 25/08; A01N 59/16; H04M 1/0202

(57) ABSTRACT

The present invention relates to an antimicrobial mobile communication device and methods of manufacturing the same.

### RELATED APPLICATIONS

This application claims priority to U.S. Provisional Patent Application Ser. No. 62/300,304 filed Feb. 26, 2016, the contents of which are hereby incorporated by reference in its entirety.

### TECHNICAL FIELD

The present invention relates to an antimicrobial mobile communication device (e.g. mobile phone or smart phone) and methods of manufacturing the same.

### BACKGROUND

Mobile communication devices have become ubiquitous. Despite their convenience and wide range of benefits, mobile devices with touchscreens can be covered with microbes and can represent a health risk. Contaminated mobile communications devices also cannot be used in applications requiring sterilized instruments such as operating rooms and sterile rooms.

### SUMMARY

In one embodiment, the invention provides a mobile communication device having an antimicrobial housing. In one embodiment, the antimicrobial housing comprises a case and a screen (e.g. a touch screen) that are embedded with or coated with one or more biocides. In one embodiment, where the biocides are embedded in the housing, the biocides are substantially homogenously embedded throughout the case, the touch screen or the housing. In one embodiment, the biocides are organic biocides. In another embodiment, the biocides are inorganic biocides. In one embodiment, the biocides are metals. In another embodiment, the biocide comprises silver and/or zinc, for example silver and/or zinc ions and/or silver and/or zinc nanoparticles (i.e. particles with a weight or number average particle size in the range of about 1 nm to about 100 nm). In another embodiment, the biocide forms a layer (e.g. transparent or rubberized layer) on a surface of the case and/or screen.

In one embodiment, the housing is resistant to water infiltration. In another embodiment, the housing is water proof when submerged up to 1 meter or more for a period of about 30 minutes (IP67). In another embodiment the housing is water and/or splash resistant (e.g. IP 54).

In another embodiment, the invention provides use of a mobile communication device as described herein in sterile room applications, for example by a surgeon or healthcare provider during surgical or other medical procedures.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. Furthermore, components can be shown as transparent in certain views for clarity of illustration only and not to indicate that the illustrated component is necessarily transparent. For ease of reference, throughout this disclosure identical reference numbers may be used to identify identical or at least generally similar or analogous components or features.

FIG. 1 shows a top view of a mobile communication device of the invention.

FIG. 2 shows a bottom view of a mobile communication device of the invention.

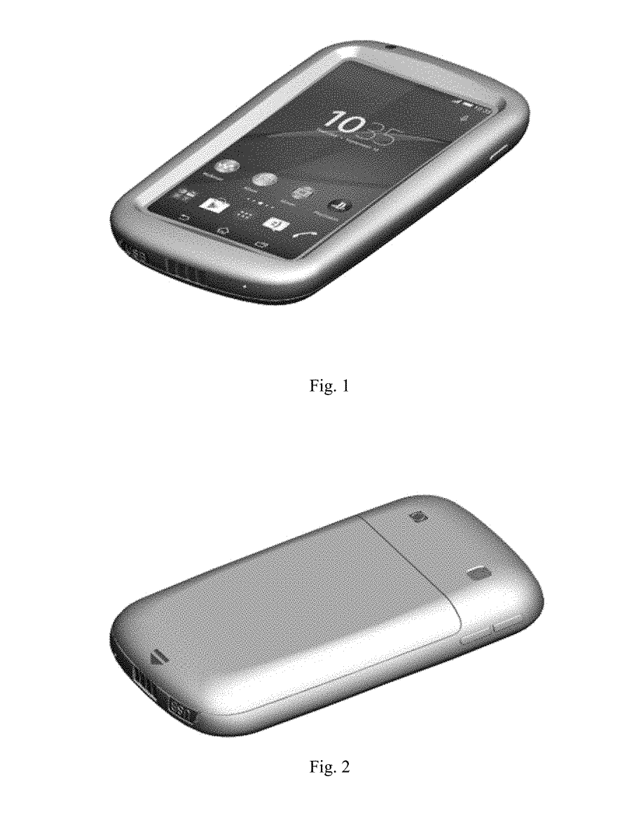

### DETAILED DESCRIPTION

In one embodiment, the invention provides a mobile communication device having an antimicrobial housing. In one embodiment, the housing comprises a case and/or a screen (e.g. a touch screen) that are embedded with or coated with one or more biocides. In one embodiment, one or more biocides are substantially uniformly distributed throughout the housing.

In any embodiment herein, the biocide is a biocide that is active against Gram positive and/or Gram negative bacteria, algae, filamentous fungi, viruses and/or yeasts and may be a general purpose biocide that is active against more than one such category of microbes. In one embodiment, the one or more biocides are organic and/or inorganic biocides.

Illustrative classes of suitable biocides include: trichlorohydroxydiphenyl ethers (e.g. 2,4,4′-trichloro-2′-hydroxydiphenylether), methylureas (e.g. 3.-(3,4-dichlorophenyl)-1,1-dimethylurea), imidazolcarbamates and/or metals, for example metal ions or metal nanoparticles

In one embodiment, the biocide comprises silver and/or zinc. In another embodiment, the biocide comprises silver and/or zinc ions. In another embodiment, the biocide comprises silver and/or zinc nanoparticles. In one embodiment, the silver and/or zinc nanoparticles have a weight or number average particle size in the range of about 1 nm to about 100 nm. In another embodiment, the biocide comprises a mixture of metal ions (e.g. zinc and/or silver) and metal nanoparticles (e.g. zinc and/or silver).

The amount of biocide incorporated into a housing will vary depending on the intended end use and the strength and nature of the particular biocide. Thus suitable amounts can readily be determined from the known mic values of the particular biocide. For example, up to 20% by weight of biocide based on the total weight of the case and/or screen. Typically useful proportions are from 0.001% to 10% by weight of the case and/or screen, for example about 0.01% to about 9%, about 0.1% to about 7%, or about 1% to about 6% 2 by weight of the case and/or the screen.

Touch Screen

The term “touch screen” herein refers to the screen portion of a mobile communication device that displays data and allows a user to interact with it by touching areas on the screen. In one embodiment, the mobile communication device housing has a touch screen comprising an alkali-aluminosilicate thin sheet (e.g. 0.4 mm to about 2 mm thick) glass having a biocide (as described herein) embedded therein, for example throughout the full thickness of the glass. In one embodiment, the alkali-aluminosilicate thin sheet glass has one or more of: a density of about 2 to about 3 g/cm³, a Young's modulus of about 50 to about 70 GPa, for example about 69 Gpa, a shear modulus of about 20 Gpa to about 30 Gpa, for example about 28 Gpa, a fracture toughness of about 0.66 Mpa m^{0.5}, a coefficient of expansion (0° C.-300° C.) of about 70 to about 80×10⁻⁷/° C., a poisson's ratio of about 0.2 to about 0.25, and/or a compressive stress greater than about 700 Mpa. In one embodiment, the one or more biocides are distributed substantially uniformly throughout the glass and does not leach to the surface.

Antimicrobial Case

The term “case” herein refers to the non-screen portion of a mobile communication device housing that encloses the electronic components, for example a microprocessor and control logic, a digital signal processor, a memory, an audio card, a battery, a microphone, an RF amplifier, etc. In various embodiments, the case is composed of one or more polymers such as thermosetting polymers, polycarbonate, ABS plastic, epoxy, polyesters, and epoxy-polyesters, acrylics and polyurethanes and thermoplastic materials, such as nylon, polyethylene, polypropylene and eva and pva.

Embedded Biocide

In one embodiment, one or more biocides as described herein are embedded in, for example substantially uniformly embedded in and distributed throughout the housing of the communication device (e.g. the case and/or the screen). In such embodiments, the biocide can be added to a plastic or polymer via a dosing unit on an injection or extrusion machine in the same way other color or additive masterbatches would be introduced to the polymer melt.

In another embodiment, a case is formed by blending masterbatches (e.g. granules or powder) of polymer, biocide and optionally color prior to heating the blend to form a polymer melt. In one embodiment, once the polymer has been molded, the biocide is situated in the polymer voids and the material is protected from colonisation from microbes.

Powder Coating

In another embodiment, one or more biocides can be coated onto the external surface of the housing (e.g. the case or screen), for example by powder coating. In another embodiment, the case comprises a rubber over plastic case wherein a biocide is embedded in the outer rubber layer.

In powder coating applications, typically the powders have a specific gravity of from 1.2 to 1.9 and a particle size of which 100% is less than 100 microns and 40 to 60% is greater than 34 microns. Thermosetting powders may have stoving temperatures, for example, of at least 120° C., e.g. 140° C. to 210° C. depending on the physical characteristics of the specific housing material used. They may also be cured by ultraviolet light or similar curing processes. Other ingredients may be included in such powders including pigments, fillers, fluidity agents, dispersants, preservatives; and the like.

In one embodiment, the powdered coating compositions of the invention may be applied by electrostatic spraying which may be manual or automatic, or by tribocharged spraying, plastics coating (fluidised bed), etc.

In one embodiment, the biocide may be incorporated in the powder which forms the matrix of the coating. As each particulate contains the biocide it is homogeneously distributed throughout the coating composition and so cannot separate out. Thus, for example, such a powder may be made by adding the biocide at the initial mixing stage of the constituents which are to be converted into the desired matrix powder. In a typical powder manufacturing process, the precursors of the desired powder, e.g. the resin base and its hardener, together with the biocide and any other additives such as pigments, fillers, are mixed, heated and extruded to sheet form, the sheet is granulated and then ground and sieved to the desired powder size. Excellent mixing of the constituents is thereby achieved and all the constituents in the desired proportions are present in each of the individual particles of the final powder.

In one embodiment, the invention provides a method of inhibiting growth of a microbe on a mobile communication device by enclosing the mobile communication device in a housing as described herein. In one embodiment, the invention provides use of a device as described herein to communicate in a sterile room. In another embodiment, the invention provides use of a device as described herein to communicate in an operating room.

What is claimed is:

1. An antimicrobial mobile communications device having a housing comprising a touch screen and a case, wherein the touch screen and the case have at least one biocide embedded therein or coated thereon.

2. The antimicrobial mobile communications device of claim 1 wherein the biocide is an inorganic or organic biocide.

3. The antimicrobial mobile communications device of claim 2 wherein the biocide comprises metal.

4. The antimicrobial mobile communications device of claim 3 wherein the biocide comprises silver and/or zinc.

5. The antimicrobial mobile communications device of claim 4 wherein the silver and/or zinc comprise silver and/or zinc ions.

6. The antimicrobial mobile communications device of claim 5 wherein the silver and/or zinc comprise silver and/or zinc nanoparticles.

7. The antimicrobial mobile communications device of claim 1 wherein the embedded biocide is distributed substantially homogeneously throughout the case.

8. The antimicrobial mobile communications device of claim 1 wherein the embedded biocide is distributed substantially homogeneously throughout the touch screen.

9. The antimicrobial mobile communications device of claim 1 wherein the embedded biocide is distributed substantially homogeneously throughout the housing.

10. The antimicrobial mobile communications device of claim 1 wherein the device is water resistant.

11. The antimicrobial mobile communications device of claim 1 wherein the device is water proof when submerged in up to 1 meter of water for a period of about 30 minutes.

12. Use of a device according to claim 1 to communicate in a sterile room.

13. Use of a device according to claim 1 to communicate in an operating room.
